(19) United States
(12) Patent Application Publication
(10) Pub. No.: US 2025/0001528 A1
(43) Pub. Date: Jan. 2, 2025

(54) SOLDER PARTICLES, SOLDER PARTICLE PRODUCTION METHOD, AND CONDUCTIVE COMPOSITION

(71) Applicant: DEXERIALS CORPORATION, Tochigi (JP)

(72) Inventors: Hidetsugu NAMIKI, Tochigi (JP); Sarii YAMAGUCHI, Tochigi (JP); Takeshi NISHIO, Tochigi (JP)

(21) Appl. No.: 18/709,619

(22) PCT Filed: Oct. 25, 2022
(86) PCT No.: PCT/JP2022/039652

§ 371 Date: May 13, 2024

(30) Foreign Application Priority Data
Nov. 15, 2021 (JP) 2021-185389

(51) Int. Cl. B23K 35/02; B22F 1/17; B23K 35/26; C22C 12/00

(52) U.S. Cl. CPC B23K 35/0244; B22F 1/17; B23K 35/264; C22C 12/00; B22F 2301/30; B22F 2998/10

(57) ABSTRACT

Solder particles include composite solder particles at a percentage of 5% by number or less in a total of the solder particles, the composite solder particles including multiple adhered solder particles. A solder particle production method includes an impact force application step of applying an impact force to solder particles so that a percentage of composite solder particles becomes 5% 10 by number or less in a total of the solder particles, the composite solder particles including multiple adhered solder particles.

### TECHNICAL FIELD

The present invention relates to solder particles, solder particle production methods, and conductive compositions.

### BACKGROUND ART

In recent years, miniaturization of pattern wiring structures is rapidly advancing, and if existing commercially available solder particles are used as they are, short circuits may occur between wiring patterns. For example, existing commercially available solder particles produced by the atomization method or the like often form composite particles 11 in which minute solder particles are adhered to the surfaces of solder particles, as illustrated in FIG. 1. When such composite solder particles 11, including adhered minute solder particles, are used in a conductive composition, normal solder particles 12 having main particle diameters move together with the flow of a binder melted upon thermocompression bonding, as illustrated in FIG. 2, while the composite solder particles 11, including adhered minute solder particles, tend to stop between wiring patterns 10, blocking the normal solder particles 12 having main particle diameters. This causes an issue that an electrical short circuit occurs between the wiring patterns 10.

Further, commercially available solder particles have broad particle size distributions, and include numerous small-particle-diameter solder particles in addition to solder particles having the intended particle diameters. When such solder particles including numerous small-particle-diameter solder particles are used in a conductive composition to attempt to electrically connect the substrates' electrode patterns that are facing each other, the normal solder particles 12 having main particle diameters are sandwiched between the electrodes and collapsed, thereby achieving conduction. However, as illustrated in FIG. 3A, small-particle-diameter solder particles 13 do not reach the electrodes and do not contribute to conduction, resulting in poor conduction. In view of this, when the amount of solder particles is increased in order to ensure conductivity, a short circuit occurs between the substrates' electrode patterns, as illustrated in FIG. 3B. Furthermore, there is an issue that the presence of a large number of small-particle-diameter solder particles reduces allowable ranges of an electrode connection area and an inter-conductor space, which are important specifications in conductive compositions.

Technically related documents propose a method for producing very minute metal powder of particles having a constant particle diameter by the centrifugal spray method (the rotating disk method). The thus-produced metal powder has a particle shape close to a true sphere and includes no minute particles adhered to the particle surfaces thereof (see, for example, Patent Document 1).

### CITATION LIST

### Patent Document

Patent Document 1: Japanese Laid-Open Patent Application No. 1994-264116

### SUMMARY OF THE INVENTION

### Technical Problem

Patent Document 1 describes that adhesion of minute particles to the particle surfaces of minute metal powder adversely affects the quality of a solder cream. However, Patent Document 1 neither describes nor suggests that the composite solder particles, including the adhered minute particles, tend to stop between wiring patterns, blocking the normal solder particles having main particle diameters, and thus an electrical short circuit occurs between the wiring patterns. Furthermore, Patent Document 1 describes a method by the centrifugal spray method (the rotating disk method) for producing minute metal powder of particles that are close to a true sphere and include no minute particles adhered thereto. However, Patent Document 1 neither describes nor suggests a method of reducing the percentage of composite solder particles from commercially available solder particles including a certain amount of composite solder particles including adhered minute solder particles.

The present invention aims to address the above-described existing issues and achieve the following object. That is, it is an object of the present invention to provide: solder particles capable of avoiding a risk of occurrence of short circuits and having high insulation performance; a production method for the solder particles; and a conductive composition including the solder particles.

### Solution to the Problem

Means for addressing the above issues are as follows.
<1> A solder particle production method, including: an impact force application step of applying an impact force to solder particles so that a percentage of composite solder particles becomes 5% by number or less in a total of the solder particles, the composite solder particles including multiple adhered solder particles.
<2> The solder particle production method according to <1>, in which the impact force is a force that is greater than gravity.
<3> The solder particle production method according to <1> or <2>, in which the impact force is applied to the solder particles by causing the solder particles to hit a wall surface, causing the solder particles to hit each other, or both.
<4> The solder particle production method according to any one of <1> to <3>, in which causing the solder particles to hit a wall surface, causing the solder particles to hit each other, or both is performed with an air flow, a centrifugal force, or both.
<5> The solder particle production method according to any one of <1> to <4>, in which in the impact force application step, classification is performed so that a percentage of small-particle-diameter solder particles becomes 1% by number or less in the total of the solder particles, the small-particle-diameter solder particles having a number particle diameter of 0.5X (μm) or less, where X (μm) denotes a number average particle diameter of the solder particles.
<6> Solder particles, including:
composite solder particles at a percentage of 5% by number or less in a total of the solder particles, the composite solder particles including multiple adhered solder particles.
<7> The solder particles according to <6>, in which a percentage of small-particle-diameter solder particles is 18 by number or less in the total of the solder particles, the small-particle-diameter solder particles having a number particle diameter of 0.5X (μm) or less, where X (μm) denotes a number average particle diameter of the solder particles.
<8> The solder particles according to <7>, in which the number average particle diameter denoted by X (μm) is 1 μm or more.
<9> The solder particles according to any one of <6> to <8>, in which the solder particles include: Sn; and at least one element selected from the group consisting of Bi, Ag, Cu, and In.
<10> A conductive composition, including: the solder particles according to any one of <6> to <9>.

### Advantageous Effects of the Invention

The present invention addresses the above-described existing issues and achieves the above object, and can provide: solder particles capable of avoiding a risk of occurrence of short circuits and having high insulation performance; a production method for the solder particles; and a conductive composition including the solder particles.

### BRIEF DESCRIPTION OF THE DRAWINGS

FIG. 1 is a diagram illustrating an example of a composite solder particle including multiple adhered solder particles.

FIG. 2 is a schematic diagram illustrating an example in which composite solder particles are used in a conductive composition and used for electrical connection between wiring patterns.

FIG. 3A is a schematic diagram illustrating a method of electrically connecting facing substrate electrodes using solder particles including small-particle-diameter solder particles in a conductive composition, and illustrating a state in which poor conduction occurs because the small-particle-diameter solder particles do not reach the electrodes.

FIG. 3B is a schematic diagram illustrating a method of electrically connecting facing substrate electrodes using solder particles including small-particle-diameter solder particles in a conductive composition, and illustrating a state in which short circuits occur when the amount of the solder particles is increased.

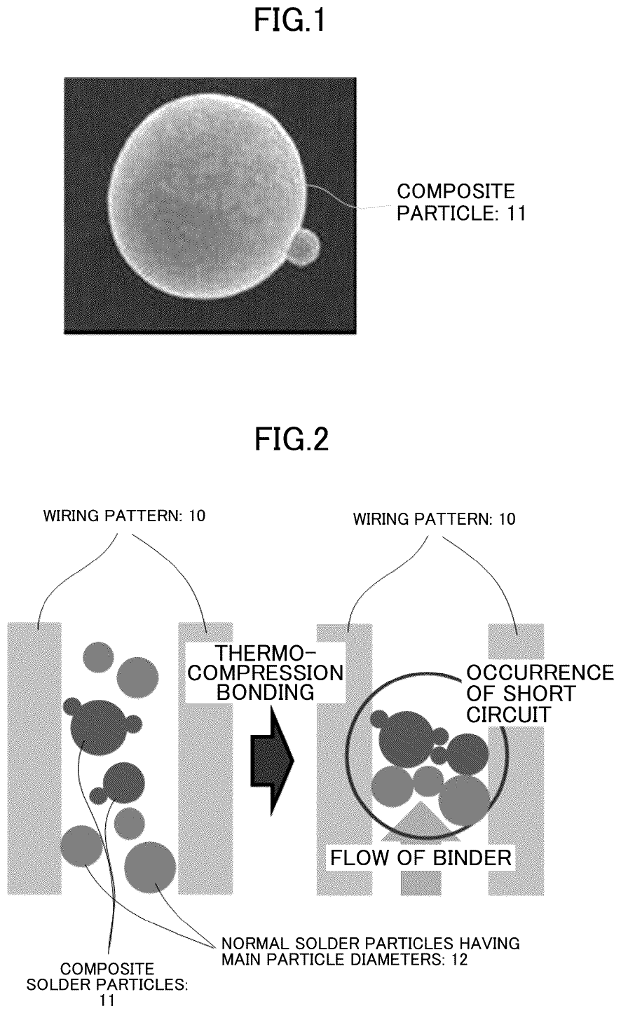

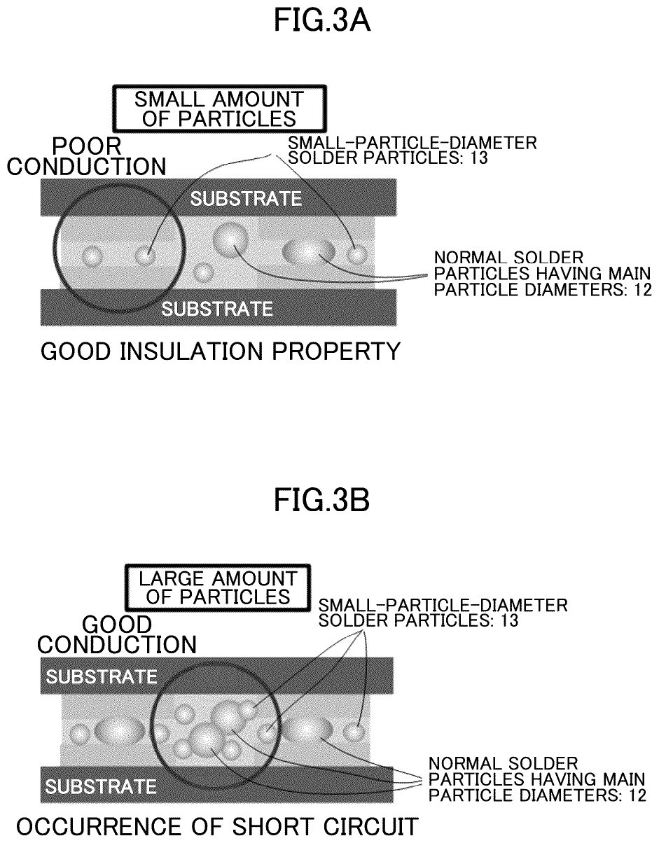

### DESCRIPTION OF THE EMBODIMENTS

### Solder Particle Production Method

The solder particle production method of the present invention includes an impact force application step of applying an impact force to solder particles so that a percentage of composite solder particles becomes 5% by number or less in a total of the solder particles, the composite solder particles including multiple adhered solder particles. If necessary, the solder particle production method of the present invention may further include other steps.

### <Impact Force Application Step>

The impact force application step is a step of applying the impact force to the solder particles so that the percentage of the composite solder particles becomes 5% by number or less in the total of the solder particles, the composite solder particles including the multiple adhered solder particles. In the impact force application step, preferably, the impact force is applied to the solder particles so that the percentage of the composite solder particles becomes 1% by number or less. More preferably, the impact force is applied to the solder particles so that the percentage of the composite solder particles becomes 0.1% by number or less. Further preferably, the impact force is applied to the solder particles so that the percentage of the composite solder particles becomes 0.05% by number or less. Particularly preferably, the impact force is applied to the solder particles so that the percentage of the composite solder particles becomes 0.01% by number or less.

By performing the above-described impact force application step, it is possible to separate the adhered minute solder particles from the composite solder particles and reduce the percentage of the composite solder particles that tend to stop between the wiring patterns and block the normal solder particles having the main particle diameters. This can avoid occurrence of an electrical short circuit between the wiring patterns.

The percentage of the composite solder particles, including the multiple adhered solder particles, can be determined in the following manner. Specifically, approximately 10,000 solder particles are measured using a dry-type, image-capturing particle size distribution analyzer (Morphologi G3, available from Malvern). Of the solder particles having a degree of true sphericity of 0.85 or more and 0.95 or less in an image captured by the dry-type, image-capturing particle size distribution analyzer, the number of composite solder particles including multiple adhered solder particles is counted to determine a percentage (number frequency) of the composite solder particles relative to the total of the solder particles.

In the impact force application step, preferably, an impact is applied to the solder particles in which the percentage of the composite solder particles, including the multiple adhered solder particles, exceeds 5% by number in the total of the solder particles. That is, by applying an impact to existing commercially available solder particles in which the percentage of the composite solder particles exceeds 5% by number before application of the impact, the adhered minute solder particles are separated and the percentage of the composite solder particles becomes 5% by number or less. Thus, it is possible to avoid occurrence of an electrical short circuit between the wiring patterns.

No particular limitation is imposed on the magnitude of the impact force as long as the adhered minute solder particles can be separated from the composite solder particles including the multiple adhered solder particles. The magnitude of the impact force may be appropriately selected in accordance with the size of the solder particles, the size of the adhered minute solder particles, the composition, and the like. Preferably, the impact force is greater than gravity. The adhesion strength of the minute solder particles to the composite particles is high, and generally, it is challenging to separate the adhered minute solder particles from the composite solder particles through sieve classification performed by manufacturers of solder particles.

The impact force is applied to the solder particles by causing the solder particles to hit a wall surface, causing the solder particles to hit each other, or both.

Causing the solder particles to hit the wall surface, causing the solder particles to hit each other, or both is performed with an air flow, a centrifugal force, or both.

A method using the air flow is preferably performed by using a swirling air flow-type sieve classifier configured to generate an air flow through blower suction, and to swirl solder particles and cause the solder particles to hit the sieve surface for classification. Examples of the swirling air flow-type sieve classifier include SPIN AIR SIEVE (available from SEISHIN ENTERPRISE Co., Ltd.) and the like.

The blower suction pressure is preferably 0.1 MPa or higher and 1.5 MPa or lower and more preferably 0.5 MPa or higher and 1.0 MPa or lower.

A method using the centrifugal force and the air flow uses a classifier in which an air vortex swirls together with solder particles in a classification chamber, and the solder particles are classified by a balance between a swirling centrifugal force generated by rotation of a rotor and an air flow toward the center of the rotor through blower suction. Examples of such a classifier include CLASSIEL (available from SEISHIN ENTERPRISE Co., Ltd.), TURBO CLASSIFIER (available from Nisshin Engineering Inc.), and the like.

The rotor speed is preferably 500 rpm or more and 2,000 rpm or less and more preferably 900 rpm or more and 1,800 rpm or less.

The blower suction air volume is preferably 2.5 m³/min or more and 3.0 m³/min or less.

In the impact force application step, preferably, classification is performed so that the percentage of small-particle-diameter solder particles becomes 1% by number or less in the total of the solder particles, the small-particle-diameter solder particles having a number particle diameter of 0.5X (μm) or less, where X (μm) denotes a number average particle diameter of the solder particles.

By performing classification so that the percentage of the small-particle-diameter solder particles becomes 1% by number or less in the total of the solder particles, the small-particle-diameter solder particles having a number particle diameter of 0.5X (μm) or less, where X (μm) denotes a number average particle diameter of the solder particles, it is possible to remove the small-particle-diameter solder particles and thus prevent poor conduction or occurrence of short circuits.

The small-particle-diameter solder particles also include small-particle-diameter solder particles separated from the composite solder particles, in addition to the small-particle-diameter solder particles that are originally included in commercially available solder particles.

The number average particle diameter and the number particle size distribution of the solder particles are determined by measuring approximately 10,000 particles using, for example, a dry-type, image-capturing particle size distribution analyzer (Morphologi G3, available from Malvern). The particle size distribution can be expressed in terms of number frequency.

### <Other Steps>

No particular limitation is imposed on the other steps, which may be appropriately selected in accordance with the intended purpose. Examples of the other steps include a washing step, a drying step, and the like.

### Solder Particles

In the solder particles of the present invention, the percentage of the composite solder particles including multiple adhered solder particles is 5% by number or less, preferably 1% by number or less, more preferably 0.1% by number or less, further preferably 0.05% by number or less, particularly preferably 0.01% by number or less, and most preferably 0% by number.

It is possible to avoid occurrence of an electrical short circuit between the wiring patterns by using the conductive composition including the solder particles of the present invention in which the percentage of the composite solder particles is 5% by number or less in the total of the solder particles.

The percentage of the composite solder particles including the multiple adhered solder particles can be measured in the same manner as in the percentage of the composite particles in the solder particle production method.

When the percentage of the composite solder particles including the multiple adhered solder particles is 5% by number or less in the total of the solder particles, the solder particles smoothly move together with the flow of the binder melted upon thermocompression bonding, and occurrence of an electrical short circuit between the wiring patterns can be avoided.

The number average particle diameter of the solder particles is preferably 1 μm or more, more preferably 5 μm or more, further preferably 10 μm or more, and particularly preferably 15 μm or more. The upper limit of the number average particle diameter of the solder particles is preferably 30 μm or less, more preferably 25 μm or less, and further preferably 20 μm or less.

The percentage of the small-particle-diameter solder particles having a number particle diameter of 0.5X (μm) (where X (μm) denotes the number average particle diameter of the solder particles) is preferably 1% by number or less in the total of the solder particles, more preferably 0.5% by number or less, further preferably 0.1% by number or less, particularly preferably 0.05% by number or less, more particularly preferably 0.01% by number or less, and most preferably 0% by number.

It is possible to prevent poor conduction or occurrence of short circuits by using the conductive composition including the solder particles of the present invention in which the percentage of the small-particle-diameter solder particles having a number particle diameter of 0.5X (μm) or less (where X (μm) denotes the number average particle diameter of the solder particles) is 1% by number or less.

The number average particle diameter and the number particle size distribution of the solder particles can be measured in the same manner as in the number average particle diameter and the number particle size distribution in the solder particle production method.

Examples of the solder particles include those defined in JIS Z3282-1999, such as Sn—Pb-based solder particles, Pb—Sn—Sb-based solder particles, Sn—Sb-based solder particles, Sn—Pb—Bi-based solder particles, Sn—Bi-based solder particles, Sn—Bi—Ag-based solder particles, Sn—Bi—Cu-based solder particles, Sn—Cu-based solder particles, Sn—Pb—Cu-based solder particles, Sn—In-based solder particles, Sn—Ag-based solder particles, Sn—Pb—Ag-based solder particles, Pb—Ag-based solder particles, Sn—Ag—Cu-based solder particles, and the like. These may be used alone or in combination.

Of these, solder particles including Sn and at least one element selected from the group consisting of Bi, Ag, Cu, and In are preferable, and Sn—Bi-based solder particles, Sn—Bi—Ag-based solder particles, Sn—Bi—Cu-based solder particles, and Sn—In solder-based particles are more preferable.

The melting point of the solder particles is preferably 110° C. or higher and 240° C. or lower and more preferably 120° C. or higher and 200° C. or lower.

### Conductive Composition

The conductive composition of the present invention includes the solder particles of the present invention, preferably includes a binder, a monofunctional polymerizable monomer, an elastomer, a curing agent, and a silane coupling agent, and if necessary further includes other components.

The conductive composition may be a film-like conductive film or may be a paste-like conductive paste. A conductive film is preferable in terms of ease of handling, and a conductive paste is preferable in terms of cost. When the conductive composition is a conductive film, a film that is free of solder particles may be stacked on the conductive film including the solder particles.

### —Solder Particles—

The solder particles for use are the solder particles of the present invention as described above.

No particular limitation is imposed on the content of the solder particles in the conductive composition, which may be appropriately adjusted in accordance with the pitch of wiring and the connection area of a connection structure, and the like.

### —Binder—

No particular limitation is imposed on the binder, which may be appropriately selected in accordance with the intended purpose. Examples of the binder include phenoxy resins, epoxy resins, unsaturated polyester resins, saturated polyester resins, urethane resins, butadiene resins, polyimide resins, polyamide resins, polyolefin resins, and the like. These may be used alone or in combination. Of these, phenoxy resins are particularly preferable in terms of film formability, processability, and connection reliability.

The phenoxy resin refers to a resin synthesized from bisphenol A and epichlorohydrin, and may be an appropriately synthesized one or may be a commercially available product. Examples of the commercially available product include, as product names, YP-50 (available from Tohto Kasei Co., Ltd.), YP-70 (available from Tohto Kasei Co., Ltd.), EP1256 (available from Japan Epoxy Resin K.K.), and the like.

No particular limitation is imposed on the content of the binder in the conductive composition, which may be appropriately selected in accordance with the intended purpose. For example, the content of the binder in the conductive composition is preferably from 20% by mass through 70% by mass and more preferably from 35% by mass through 55% by mass.

### —Monofunctional Polymerizable Monomer—

No particular limitation is imposed on the monofunctional polymerizable monomer as long as the monofunctional polymerizable monomer includes one polymerizable group in a molecule thereof. The monofunctional polymerizable monomer may be appropriately selected in accordance with the intended purpose. Examples of the monofunctional polymerizable monomer include monofunctional (meth)acrylic monomers, styrene monomers, butadiene monomers, and other monomers, such as double bond-including olefin-based monomers and the like. These may be used alone or in combination. Of these, monofunctional (meth)acrylic monomers are particularly preferable in terms of adhesive strength and connection reliability.

No particular limitation is imposed on the monofunctional (meth)acrylic monomer, which may be appropriately selected in accordance with the intended purpose. Examples of the monofunctional (meth)acrylic monomer include: acrylic acid and esters thereof, such as acrylic acid, methyl acrylate, ethyl acrylate, propyl acrylate, n-butyl acrylate, isobutyl acrylate, n-octyl acrylate, n-dodecyl acrylate, 2-ethylhexyl acrylate, stearyl acrylate, 2-chloroethyl acrylate, phenyl acrylate, and the like; and methacrylic acid and esters thereof, such as methacrylic acid, methyl methacrylate, ethyl methacrylate, propyl methacrylate, n-butyl methacrylate, isobutyl methacrylate, n-octyl methacrylate, n-dodecyl methacrylate, 2-ethylhexyl methacrylate, stearyl methacrylate, phenyl methacrylate, dimethylaminoethyl methacrylate, diethylaminoethyl methacrylate, and the like. These may be used alone or in combination.

No particular limitation is imposed on the content of the monofunctional polymerizable monomer in the conductive composition, which may be appropriately selected in accordance with the intended purpose. The content of the monofunctional polymerizable monomer is preferably 2% by mass or more and 30% by mass or less and more preferably 5% by mass or more and 20% by mass or less.

### —Curing Agent—

No particular limitation is imposed on the curing agent as long as the curing agent can cure the binder. The curing agent may be appropriately selected in accordance with the intended purpose. It is preferable to use an organic peroxide or the like as the curing agent.

Examples of the organic peroxide include lauroyl peroxide, butyl peroxide, benzyl peroxide, dilauroyl peroxide, dibutyl peroxide, benzyl peroxide, peroxydicarbonate, benzoyl peroxide, and the like. These may be used alone or in combination.

No particular limitation is imposed on the content of the curing agent in the conductive composition, which may be appropriately selected in accordance with the intended purpose. The content of the curing agent in the conductive composition is preferably 1% by mass or more and 15% by mass or less and more preferably 3% by mass or more and 10% by mass or less.

### —Elastomer—

No particular limitation is imposed on the elastomer, which may be appropriately selected in accordance with the intended purpose. Examples of the elastomer include polyurethane-based elastomers, acrylic rubber, silicone rubber, butadiene rubber, and the like. These may be used alone or in combination.

### —Silane Coupling Agent—

No particular limitation is imposed on the silane coupling agent, which may be appropriately selected in accordance with the intended purpose. Examples of the silane coupling agent include epoxy-based silane coupling agents, acrylic silane coupling agents, thiol-based silane coupling agents, amine-based silane coupling agents, and the like.

No particular limitation is imposed on the content of the silane coupling agent in the conductive composition, which may be appropriately selected in accordance with the intended purpose. The content of the silane coupling agent in the conductive composition is preferably 0.5% by mass or more and 10% by mass or less and more preferably 1% by mass or more and 5% by mass or less.

### —Other Components—

No particular limitation is imposed on the other components, which may be appropriately selected in accordance with the intended purpose. Examples of the other components include organic solvents, fillers, softeners, accelerators, antiaging agents, colorants (pigments, dyes), ion catchers, and the like. No particular limitation is imposed on the amount of the other components, which may be appropriately selected in accordance with the intended purpose.

### <Applications>

Because the solder particles and the conductive composition of the present invention can avoid a risk of occurrence of short circuits, these can be used to make an electrical connection between electrodes of various connection target members, such as a connection between a flexible printed circuit and a glass substrate (FOG (Film on Glass)), a connection between a semiconductor chip and a flexible printed circuit (COF (Chip on Film)), a connection between a semiconductor chip and a glass substrate (COG (Chip on Glass)), a connection between a flexible printed circuit and a glass epoxy substrate (FOB (Film on Board)), and the like.

### EXAMPLES

The present invention will be described below by way of examples. However, the present invention is not limited to the examples in any way.

### Measurement of Particle Size Distribution

Approximately 10,000 particles were measured using a dry-type, image-capturing particle size distribution analyzer (Morphologi G3, obtained from Malvern) and the particle size distribution was expressed in terms of number frequency.

### Percentage of Composite Solder Particles Including Multiple Adhered Solder Particles

Approximately 10,000 solder particles were measured using a dry-type, image-capturing particle size distribution analyzer (Morphologi G3, obtained from Malvern). Of the solder particles having a degree of true sphericity of 0.85 or more and 0.95 or less in an image captured by the dry-type, image-capturing particle size distribution analyzer, the number of composite solder particles including multiple adhered solder particles was counted to determine a percentage (number frequency) of the composite solder particles relative to the total of the solder particles.

### Example 1

### Classification of Solder Particles

Sn₄₂Bi₅₈-Type5 (obtained from Mitsui Mining & Smelting Co., Ltd.) was provided as the solder particles. As a result of measuring the Sn₄₂Bi₅₈-Type5 by the dry-type, image-capturing particle size distribution analyzer (Morphologi G3, obtained from Malvern), the particle size distribution was from 15 μm through 25 μm, the cumulative 50% number particle diameter (D₅₀) was 20 μm, and the percentage of the small-particle-diameter solder particles having a number particle diameter of 10 μm or less was 8% by number. The percentage of composite solder particles including multiple adhered solder particles was 8% by number relative to the total of the solder particles.

A twill metal sieve (obtained from Tokyo Screen Co., Ltd.) having a diameter of 200 mm and an opening of 16 μm was set in SPIN AIR SIEVE (obtained from SEISHIN ENTERPRISE Co., Ltd.) which in turn was suctioned with a blower so as to have a suction pressure of 0.5 MPa. 50 g of the solder particles was charged through a raw material supply port. This was driven for 5 minutes from the charge of the raw material until the end of classification. The particles on the coarse powder side remaining under the sieve were recovered through classification performed once by a forced air flow-type classification treatment. In this manner, classification for removing the small-particle-diameter solder particles was performed to obtain classified solder particles of Example 1.

As a result of measuring the obtained classified solder particles by the dry-type, image-capturing particle size distribution analyzer (Morphologi G3, obtained from Malvern), the percentage of the small-particle-diameter solder particles having a number particle diameter of 10 μm or less was 0.10% by number. The percentage of the composite solder particles including the multiple adhered solder particles was 1.5% by number relative to the total of the solder particles.

### Preparation of Conductive Film

5 parts by mass of the produced solder particles of Example 1 and 95 parts by mass of the following insulating binder were charged into a planetary stirrer, followed by stirring for 1 minute, thereby preparing a conductive composition.

Next, the conductive composition was coated on a PET film having a thickness of 50 μm and dried in an oven of 80° C. for 5 minutes. A 25 μm-thick tacky layer formed of the conductive composition was formed on the PET film, thereby preparing a conductive film having a width of 2.0 mm.

### —Insulating Binder—

The insulating binder was a mixed solution of ethyl acetate and toluene, including 47 parts by mass of a phenoxy resin (product name: YP-50, obtained from NSCC Epoxy Manufacturing Co., Ltd.), 3 parts by mass of a monofunctional monomer (product name: M-5300, obtained from TOAGOSEI CO., LTD.), 25 parts by mass of a urethane resin (product name: UR-1400, obtained from TOYOBO CO., LTD.), 15 parts by mass of a rubber component (product name: SG80H, obtained from Nagase ChemteX Corporation), 2 parts by mass of a silane coupling agent (product name: A-187, obtained from Momentive Performance Materials Japan), and 3 parts by mass of an organic peroxide (product name: NYPER BW, obtained from NOF CORPORATION) SO that the solid content was 50% by mass.

### Production of Connection Structure

A connection structure was produced by performing thermal pressure bonding, via the above conductive film, between: a substrate for evaluation (glass epoxy substrate (FR4), 50 μm in pitch, 30 μm in space, 10 μm in terminal thickness, Cu (base)/Ni/Au plating); and an FPC (polyimide film, 50 μm in pitch, 30 μm in space, 12 μm in terminal thickness, Cu (base)/Ni/Au plating).

The thermal pressure bonding was performed under the conditions: temperature: 150° C., pressure: 2 MPa, and time: 20 sec by pressing down a tool via 200 μm-thick silicone rubber on the FPC using a constantly heated head pressure bonder.

### Evaluation of Conduction Characteristics

Using a digital multimeter (obtained from Yokogawa Electric Corporation), the produced connection structure was measured for: initial conduction resistance (initial conductivity) when a current of 1 mA was applied using the 4-terminal method; and conduction resistance (conduction reliability) after the produced connection structure was stored in an oven of 85° C. and 85% RH for 500 hours, followed by evaluation in accordance with the following criteria.

### [Evaluation Criteria]

A: The conduction resistance was 1Ω or lower.
B: The conduction resistance exceeded 1Ω.
C: The conductive resistance was OPEN.

### Evaluation of Initial Insulation Property

A voltage was applied between the patterns of the connection structure, and the initial insulation resistance was measured to confirm the presence or absence of a short circuit. An initial insulation resistance of 1×10⁵Ω or lower was evaluated as occurrence of a short circuit.

### Example 2

### Classification of Solder Particles

The forced air flow-type classification treatment was performed in the same manner as in Example 1 except that unlike in Example 1, the number of classification treatments by SPIN AIR SIEVE in the classification conditions was changed from once to three times, thereby producing classified solder particles of Example 2.

As a result of measuring the obtained classified solder particles by the dry-type, image-capturing particle size distribution analyzer (Morphologi G3, obtained from Malvern), the percentage of the small-particle-diameter solder particles having a number particle diameter of 10 μm or less was 0.01% by number. The percentage of the composite solder particles including the multiple adhered solder particles was 0.2% by number relative to the total of the solder particles.

### Production of Conductive Film, Production of Connection Structure, and Evaluation

A conductive film and a connection structure were produced using the produced solder particles of Example 2 and evaluated in the same manner as in Example 1. The results are shown in Table 1.

### Example 3

### Classification of Solder Particles

The forced air flow-type classification treatment was performed in the same manner as in Example 1 except that unlike in Example 1, the suction pressure in the classification conditions was changed to 1 MPa, thereby producing classified solder particles of Example 3.

As a result of measuring the obtained classified solder particles by the dry-type, image-capturing particle size distribution analyzer (Morphologi G3, obtained from Malvern), the percentage of the small-particle-diameter solder particles having a number particle diameter of 10 μm or less was 0.05% by number. The percentage of the composite solder particles including the multiple adhered solder particles was 0.7% by number relative to the total of the solder particles.

### Production of Conductive Film, Production of Connection Structure, and Evaluation

A conductive film and a connection structure were produced using the produced solder particles of Example 3 and evaluated in the same manner as in Example 1. The results are shown in Table 1.

### Example 4

The forced air flow-type classification treatment was performed in the same manner as in Example 2 except that unlike in Example 2, zirconia balls having a diameter of 100 μm were added to the solder particles, followed by classification together, thereby producing classified solder particles of Example 4.

As a result of measuring the obtained classified solder particles by the dry-type, image-capturing particle size distribution analyzer (Morphologi G3, obtained from Malvern), the percentage of the small-particle-diameter solder particles having a number particle diameter of 10 μm or less was 0.00% by number. The percentage of the composite solder particles including the multiple adhered solder particles was 0% by number relative to the total of the solder particles.

### Production of Conductive Film, Production of Connection Structure, and Evaluation

A conductive film and a connection structure were produced using the produced solder particles of Example 4 and evaluated in the same manner as in Example 1. The results are shown in Table 2.

### Example 5

### Classification of Solder Particles

The forced air flow-type classification treatment was performed in the same manner as in Example 1 except that unlike in Example 1, Sn₄₂Bi₅₈-Type5 was changed to Sn₄₂Bi₅₈Ag₁-Type5 (obtained from Senju Metal Industry Co., Ltd.), thereby producing classified solder particles of Example 5.

As a result of measuring Sn₄₂Bi₅₈Ag₁-Type5 by the dry-type, image-capturing particle size distribution analyzer (Morphologi G3, obtained from Malvern), the particle size distribution was from 15μm through 25 μm, the cumulative 50% number particle diameter (D₅₀) was 20 μm, and the percentage of the small-particle-diameter solder particles having a number particle diameter of 10 μm or less was 6% by number. The percentage of composite solder particles including multiple adhered solder particles was 10% by number relative to the total of the solder particles.

As a result of measuring the obtained classified solder particles by the dry-type, image-capturing particle size distribution analyzer (Morphologi G3, obtained from Malvern), the percentage of the small-particle-diameter solder particles having a number particle diameter of 10 μm or less was 0.04% by number. The percentage of the composite solder particles including the multiple adhered solder particles was 0.7% by number relative to the total of the solder particles.

### Production of Conductive Film, Production of Connection Structure, and Evaluation

A conductive film and a connection structure were produced using the produced solder particles of Example 5 and evaluated in the same manner as in Example 1. The results are shown in Table 2.

### Example 6

### Classification of Solder Particles

Sn₄₂Bi₅₈-Type5 (obtained from Mitsui Mining & Smelting Co., Ltd.) was used as the solder particles. The Sn₄₂Bi₅₈-Type5 was suctioned by rotating a rotor attached to TURBO CLASSIFIER (obtained from Nisshin Engineering Inc.) at 1,300 rpm, and further suctioned with a blower at an intensity of 2.6 m³/min. 200 g of the solder particles was charged through a raw material supply port. This was driven for 4 minutes from the charge of the raw material until the end of classification. The particles on the minute powder side were recovered through classification performed once by a forced air flow-type classification treatment, thereby obtaining classified solder particles of Example 6.

As a result of measuring the obtained classified solder particles by the dry-type, image-capturing particle size distribution analyzer (Morphologi G3, obtained from Malvern), the percentage of the small-particle-diameter solder particles having a number particle diameter of 10 μm or less was 0.20% by number. The percentage of the composite solder particles including the multiple adhered solder particles was 2.0% by number relative to the total of the solder particles.

### Production of Conductive Film, Production of Connection Structure, and Evaluation

A conductive film and a connection structure were produced using the produced solder particles of Example 6 and evaluated in the same manner as in Example 1. The results are shown in Table 2.

### Example 7

### Classification of Solder Particles

The forced air flow-type classification treatment was performed in the same manner as in Example 6 except that unlike in Example 6, the rotor speed was changed to 1,600 rpm and the suction air volume was changed to 2.8 m³/min in the classification conditions, thereby producing classified solder particles of Example 7.

As a result of measuring the obtained classified solder particles by the dry-type, image-capturing particle size distribution analyzer (Morphologi G3, obtained from Malvern), the percentage of the small-particle-diameter solder particles having a number particle diameter of 10 μm or less was 0.05% by number. The percentage of the composite solder particles including the multiple adhered solder particles was 1.0% by number relative to the total of the solder particles.

### Production of Conductive Film, Production of Connection Structure, and Evaluation

A conductive film and a connection structure were produced using the produced solder particles of Example 7 and evaluated in the same manner as in Example 1. The results are shown in Table 3.

### Example 8

### Classification of Solder Particles

Sn₄₂Bi₅₈-Type5 (obtained from Mitsui Mining & Smelting Co., Ltd.) was used as the solder particles. The Sn₄₂Bi₅₈-Type5 was suctioned by rotating a rotor attached to TURBO CLASSIFIER (obtained from Nisshin Engineering Inc.) at 1,200 rpm, and further suctioned with a blower at an intensity of 2.8 m³/min. 200 g of the solder particles was charged through a raw material supply port, and coarse particles having a particle diameter of greater than 25 μm were cut through classification.

The forced air flow-type classification treatment was performed in the same manner as in Example 7 except that unlike in Example 7, solder particles from which the coarse particles having a particle diameter of greater than 25 μm were cut through classification were used, thereby producing classified solder particles of Example 8.

As a result of measuring the obtained classified solder particles by the dry-type, image-capturing particle size distribution analyzer (Morphologi G3, obtained from Malvern), the percentage of the small-particle-diameter solder particles having a number particle diameter of less than 10 μm was 0.05% by number. The percentage of the composite solder particles including the multiple adhered solder particles was 0.5% by number relative to the total of the solder particles.

### Production of Conductive Film, Production of Connection Structure, and Evaluation

A conductive film and a connection structure were produced using the produced solder particles of Example 8 and evaluated in the same manner as in Example 1. The results are shown in Table 3.

### Comparative Example 1

Sn₄₂Bi₅₈-Type5 (obtained from Mitsui Mining & Smelting Co., Ltd.) was used as is without classification as the solder particles.

As a result of measuring the solder particles of Comparative Example 1 by the dry-type, image-capturing particle size distribution analyzer (Morphologi G3, obtained from Malvern), the percentage of the small-particle-diameter solder particles having a number particle diameter of 10 μm or less was 8% by number. The percentage of the composite solder particles including the multiple adhered solder particles was 8.0% by number relative to the total of the solder particles.

### Production of Conductive Film, Production of Connection Structure, and Evaluation

A conductive film and a connection structure were produced using the solder particles of Comparative Example 1 and evaluated in the same manner as in Example 1. The results are shown in Table 4.

### Comparative Example 2

### Classification of Solder Particles

Sn₄₂Bi₅₈-Type5 (obtained from Mitsui Mining & Smelting Co., Ltd.) was used as the solder particles. The Sn₄₂Bi₅₈-Type5 was subjected to classification for removing small-particle-diameter solder particles by a sieve shaker (VUD-80, obtained from TSUTSUI SCIENTIFIC INSTRUMENTS Co., Ltd.) using a #16 μm-opening sieve, thereby producing classified solder particles of Comparative Example 2.

As a result of measuring the obtained classified solder particles by the dry-type, image-capturing particle size distribution analyzer (Morphologi G3, obtained from Malvern), the percentage of the small-particle-diameter solder particles having a number particle diameter of 10 μm or less was 1% by number. The percentage of the composite solder particles including the multiple adhered solder particles was 7.0% by number relative to the total of the solder particles.

### Production of Conductive Film, Production of Connection Structure, and Evaluation

A conductive film and a connection structure were produced using the produced solder particles of Comparative Example 2 and evaluated in the same manner as in Example 1. The results are shown in Table 4.

TABLE 1

| | | | Example 1 | Example 2 | Example 3 |
|---|---|---|---|---|---|
| Material | Solder | Material | Sn₄₂Bi₅₈ | Sn₄₂Bi₅₈ | Sn₄₂Bi₅₈ |
| | particles | Type of particle | Type5 | Type5 | Type5 |
| | | diameter | | | |
| | | Cumulative 50% | 20 μm | 20 μm | 20 μm |
| | | number particle | | | |
| | | diameter (D₅₀) | | | |
| | | Percentage of | 8% by | 8% by | 8% by |
| | | small-particle- | number | number | number |
| | | diameter solder | | | |
| | | particles having a | | | |
| | | particle diameter | | | |
| | | of 10 μm or less | | | |
| | | Percentage of | 8.0% by | 8.0% by | 8.0% by |
| | | composite | number | number | number |
| | | particles | | | |
| Classification | Classification | Classifier | SPIN AIR | SPIN AIR | SPIN AIR |
| | conditions | | SIEVE | SIEVE | SIEVE |
| | | Opening of sieve | 16 μm | 16 μm | 16 μm |
| | | Classification | Suction | Suction | Suction |
| | | conditions | pressure = | pressure = | pressure = |
| | | | 0.5 MPa | 0.5 MPa | 1 MPa |
| | | Number of | Once | Three times | Once |
| | | classification | | | |
| | | treatments | | | |
| | Classified | Percentage of | 0.10% by | 0.01% by | 0.05% by |
| | solder | small-particle- | number | number | number |
| | particles | diameter solder | | | |
| | | particles having a | | | |
| | | particle diameter | | | |
| | | of 10 μm or less | | | |
| | | Percentage of | 1.5% by | 0.2% by | 0.7% by |
| | | composite | number | number | number |
| | | particles | | | |

| | | | | |
|---|---|---|---|---|
| Evaluation | Evaluation of initial | A | A | A |
| | conductivity | | | |
| | Evaluation of conduction | A | A | A |
| | reliability | | | |
| | (85° C. 85% RH-500 hr) | | | |
| | Evaluation of initial insulation | No occurrence | No occurrence | No occurrence |
| | property | of short circuit | of short circuit | of short circuit |
| | (presence or absence of short | | | |
| | circuit) | | | |

TABLE 2

| | | | Example 4 | Example 5 | Example 6 |
|---|---|---|---|---|---|
| Material | Solder | Material | Sn₄₂Bi₅₈ | Sn₄₂Bi₅₇Ag₁ | Sn₄₂Bi₅₈ |
| | particles | Type of particle | Type5 | Type5 | Type5 |
| | | diameter | | | |
| | | Cumulative 50% | 20 μm | 20 μm | 20 μm |
| | | number particle | | | |
| | | diameter (D₅₀) | | | |
| | | Percentage of small- | 8% by | 6% by | 8% by |
| | | particle-diameter | number | number | number |
| | | solder particles | | | |
| | | having a particle | | | |
| | | diameter of 10 μm or | | | |
| | | less | | | |
| | | Percentage of | 8.0% by | 10.0% by | 8.0% by |
| | | composite particles | number | number | number |
| Classification | Classification | Classifier | SPIN AIR | SPIN AIR | TURBO |
| | conditions | | SIEVE | SIEVE | CLASSIFIER |
| | | Opening of sieve | 16 μm | 16 μm | No sieve used |
| | | Classification | Suction | Suction | Rotor speed = |
| | | conditions | pressure = | pressure = | 1,300 rpm |
| | | | 0.5 MPa | 1 MPa | Suction air |
| | | | | | volume = |
| | | | | | 2.6 m³/min |
| | | Number of | Three times | Once | Once |
| | | classification | (Zirconia balls | | |
| | | treatments | having a | | |
| | | | diameter of 100 | | |
| | | | μm were added | | |
| | | | to solder | | |
| | | | particles, | | |
| | | | followed by | | |
| | | | classification | | |
| | | | together) | | |
| | Classified | Percentage of small- | 0.00% by | 0.04% by | 0.20% by |
| | solder | particle-diameter | number | number | number |
| | particles | solder particles | | | |
| | | having a particle | | | |
| | | diameter of 10 μm or | | | |
| | | less | | | |
| | | Percentage of | 0% by | 0.7% by | 2.0% by |
| | | composite particles | number | number | number |

| | | | | |
|---|---|---|---|---|
| Evaluation | Evaluation of initial conductivity | A | A | A |
| | Evaluation of conduction | A | A | A |
| | reliability | | | |
| | (85° C. 85% RH-500 hr) | | | |
| | Evaluation of initial insulation | No occurrence | No occurrence | No occurrence |
| | property | of short circuit | of short circuit | of short circuit |
| | (presence or absence of short | | | |
| | circuit) | | | |

TABLE 3

| | | | Example 7 | Example 8 |
|---|---|---|---|---|
| Material | Solder | Material | Sn₄₂Bi₅₈ | Sn₄₂Bi₅₈ |
| | particles | Type of particle | Type5 | Type5 |
| | | diameter | | (>25 μm |
| | | | | cut through |
| | | | | classification) |
| | | Cumulative 50% | 20 μm | 20 μm |
| | | number particle | | |
| | | diameter (D₅₀) | | |
| | | Percentage of | 8% by | 8% by |
| | | small-particle- | number | number |
| | | diameter solder | | |
| | | particles having a | | |
| | | particle diameter | | |
| | | of 10 μm or less | | |
| | | Percentage of | 8.0% by | 8.0% by |
| | | composite | number | number |
| | | particles | | |
| Classification | Classification | Classifier | TURBO | TURBO |
| | conditions | | CLASSIFIER | CLASSIFIER |
| | | Opening of sieve | No sieve used | No sieve used |
| | | Classification | Rotor speed = | Rotor speed = |
| | | conditions | 1,600 rpm | 1,600 rpm |
| | | | Suction air | Suction air |
| | | | volume = | volume = |
| | | | 2.8 m³/min | 2.8 m³/min |
| | | Number of | Once | Once |
| | | classification | | |
| | | treatments | | |
| | Classified | Percentage of | 0.05% by | 0.05% by |
| | solder | small-particle- | number | number |
| | particles | diameter solder | | |
| | | particles having a | | |
| | | particle diameter | | |
| | | of 10 μm or less | | |
| | | Percentage of | 1.0% by | 0.5% by |
| | | composite | number | number |
| | | particles | | |

| | | | |
|---|---|---|---|
| Evaluation | Evaluation of initial | A | A |
| | conductivity | | |
| | Evaluation of conduction | A | A |
| | reliability | | |
| | (85° C. 85% RH-500 hr) | | |
| | Evaluation of initial insulation | No occurrence | No occurrence |
| | property | of short circuit | of short circuit |
| | (presence or absence of short | | |
| | circuit) | | |

TABLE 4

| | | | Comparative | Comparative |
|---|---|---|---|---|
| | | | Example 1 | Example 2 |
| Material | Solder | Material | Sn₄₂Bi₅₈ | Sn₄₂Bi₅₈ |
| | particles | Type of particle | Type5 | Type5 |
| | | diameter | | |
| | | Cumulative 50% | 20 μm | 20 μm |
| | | number particle | | |
| | | diameter (D₅₀) | | |
| | | Percentage of | 8% by | 8% by |
| | | small-particle- | number | number |
| | | diameter solder | | |
| | | particles having a | | |
| | | particle diameter | | |
| | | of 10 μm or less | | |
| | | Percentage of | 8.0% by | 8.0% by |
| | | composite | number | number |
| | | particles | | |
| Classification | Classification | Classifier | — | Vibration sieve |
| | conditions | Opening of sieve | — | 16 μm |
| | | Classification | — | — |
| | | conditions | | |
| | | Number of | — | Once |
| | | classification | | |
| | | treatments | | |
| | Classified | Percentage of | 8% by | 1% by |
| | solder | small-particle- | number | number |
| | particles | diameter solder | | |
| | | particles having a | | |
| | | particle diameter | | |
| | | of 10 μm or less | | |
| | | Percentage of | 8.0% by | 7.0% by |
| | | composite | number | number |
| | | particles | | |
| Evaluation | Evaluation of initial | | A | A |

| | | |
|---|---|---|
| conductivity | | |
| Evaluation of conduction | B | A |
| reliability | | |
| (85° C. 85% RH-500 hr) | | |
| Evaluation of initial insulation | Occurrence of | Occurrence of |
| property | short circuit | short circuit |
| (presence or absence of short | | |
| circuit) | | |

From the results of Table 1 to Table 4, it was found that all of Examples 1 to 8 exhibit good values of the initial conduction resistance, the conduction resistance after 85° C. and 85%-500 hours, and the initial insulation resistance.

In Comparative Example 1, the initial conduction resistance was good, but the conduction resistance after 85° C. and 85%-500 hours increased to 1.5Ω. As a result of cross-sectional SEM observation of a particle/substrate electrode portion of the thermal-pressure bonded sample using a scanning electron microscope (SEM) (JSM-6510A, obtained from JEOL Ltd.), it was confirmed that there were numerous small-particle-diameter solder particles not being in contact with the electrodes. Also, in terms of the initial insulation resistance, a short circuit occurred. When observing the space between the electrode patterns where the short circuit occurred, it was confirmed that the solder particles were blocked and the solder particles densely gathered between the electrode patterns.

In Comparative Example 2, both of the initial conduction resistance and the conduction resistance after 85° C. and 85%-500 hours were good. However, in terms of the initial insulation resistance, a short circuit occurred. When observing, under a SEM, the space between the electrode patterns where the short circuit occurred, it was confirmed that the solder particles were blocked and the solder particles densely gathered between the electrode patterns.

From the above results, by classifying the composite solder particles including the multiple adhered solder particles while applying the impact force thereto, it was possible to separate the minute solder particles adhering to the solder particles, and at the same time to produce the solder particles from which the separated minute solder particles and the originally existing small-particle-diameter solder particles were removed. By using the obtained solder particles, a conductive composition capable of avoiding a risk of occurrence of short circuits between the wiring patterns was obtained.

### INDUSTRIAL APPLICABILITY

Because the solder particles obtained by the solder particle production method of the present invention, and the conductive composition can avoid a risk of occurrence of short circuits, these can be successfully used for a flexible printed circuit (FPC), a connection between an IC chip terminal and an ITO (Indium Tin Oxide) electrode formed on a glass substrate of an LCD panel, a connection between a COF and a PWB, a connection between a TCP and a PWB, a connection between a COF and a glass substrate, a connection between a COF and a COF, a connection between an IC substrate and a glass substrate, a connection between an IC substrate and a PWB, and the like.

The present international application claims priority to Japanese Patent Application No. 2021-185389 filed on Nov. 15, 2021, and the entire contents of Japanese Patent Application No. 2021-185389 are incorporated in the present international application by reference.

### REFERENCE SIGNS LIST

10 Wiring pattern
11 Composite solder particles
12 Normal solder particles having main particle diameter
13 Small-particle-diameter solder particles

1. A solder particle production method, comprising:
applying an impact force to solder particles so that a percentage of composite solder particles becomes 5% by number or less in a total of the solder particles, the composite solder particles including multiple adhered solder particles.

2. The solder particle production method according to claim 1, wherein
the impact force is a force that is greater than gravity.

3. The solder particle production method according to claim 1, wherein
the impact force is applied to the solder particles by causing the solder particles to hit a wall surface, causing the solder particles to hit each other, or both.

4. The solder particle production method according to claim 1, wherein
causing the solder particles to hit a wall surface, causing the solder particles to hit each other, or both is performed with an air flow, a centrifugal force, or both.

5. The solder particle production method according to claim 1, wherein
in the application of the impact force, classification is performed so that a percentage of small-particle-diameter solder particles becomes 1% by number or less in the total of the solder particles, the small-particle-diameter solder particles having a number particle diameter of 0.5X (μm) or less, where X (μm) denotes a number average particle diameter of the solder particles.

6. Solder particles, comprising:
composite solder particles at a percentage of 5% by number or less in a total of the solder particles, the composite solder particles including multiple adhered solder particles.

7. The solder particles according to claim 6, wherein
a percentage of small-particle-diameter solder particles is 1% by number or less in the total of the solder particles, the small-particle-diameter solder particles having a number particle diameter of 0.5X (μm) or less, where X (μm) denotes a number average particle diameter of the solder particles.

8. The solder particles according to claim 7, wherein
the number average particle diameter denoted by X (μm) is 1 μm or more.

9. The solder particles according to claim 6, wherein
the solder particles include
Sn, and
at least one element selected from the group consisting of Bi, Ag, Cu, and In.

10. A conductive composition, comprising:
the solder particles according to claim 6.

11. The solder particle production method according to claim 2, wherein
the impact force is applied to the solder particles by causing the solder particles to hit a wall surface, causing the solder particles to hit each other, or both.

12. The solder particle production method according to claim 2, wherein
causing the solder particles to hit the wall surface, causing the solder particles to hit each other, or both is performed with an air flow, a centrifugal force, or both.

13. The solder particle production method according to claim 3, wherein
causing the solder particles to hit the wall surface, causing the solder particles to hit each other, or both is performed with an air flow, a centrifugal force, or both.

14. The solder particle production method according to claim 2, wherein
in the application of the impact force, classification is performed so that a percentage of small-particle-diameter solder particles becomes 1% by number or less in the total of the solder particles, the small-particle-diameter solder particles having a number particle diameter of 0.5X (μm) or less, where X (μm) denotes a number average particle diameter of the solder particles.

15. The solder particle production method according to claim 3, wherein
in the application of the impact force, classification is performed so that a percentage of small-particle-diameter solder particles becomes 1% by number or less in the total of the solder particles, the small-particle-diameter solder particles having a number particle diameter of 0.5X (μm) or less, where X (μm) denotes a number average particle diameter of the solder particles.

16. The solder particle production method according to claim 4, wherein
in the application of the impact force, classification is performed so that a percentage of small-particle-diameter solder particles becomes 1% by number or less in the total of the solder particles, the small-particle-diameter solder particles having a number particle diameter of 0.5X (μm) or less, where X (μm) denotes a number average particle diameter of the solder particles.
